(19) United States
(12) Patent Application Publication
(10) Pub. No.: US 2006/0050925 A1
(43) Pub. Date: Mar. 9, 2006

(54) Method of determining authenticity and watermark reader

(75) Inventor: Kohji Mitsubayashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: TOKYO MEDICAL AND DENTAL UNIVERSITY, Tokyo (JP); PIXEN INC., Tokyo (JP)

(21) Appl. No.: 11/073,854

(22) Filed: Mar. 8, 2005

(30) Foreign Application Priority Data
Sep. 8, 2004 (JP) 2004-260452

(51) Int. Cl. G06K 9/00

(52) U.S. Cl. 382/100

(57) ABSTRACT

A “watermark” technology in which not only can a “watermark” be applied to an object without requiring a sophisticated technology or a large cost and be utilized as an aid to authentication by applying the “watermark” widely to general tangible goods but also the five senses of human can not sense that “watermark” itself is put on is provided. At least one kind of material (substrate, for example, hydrogen peroxide, lactic acid, choline) is applied to an object as “watermark”, whether or not the material is diffusing from the object is detected by a detecting unit (biosensor) using a biomaterial (for example, enzyme), and whether or not the material has been applied to the object is determined from the detection result.

### FIELD OF THE INVENTION

The present invention relates to a technology for determining authenticity with the use of so-called “watermark”. More specifically, the present invention relates to a “watermark” technology and a technology of “watermark” reading as an applied technology of a biosensor (bio-sniffer) that detects, for example, an odorless gas unperceivable by human olfaction with the use of a biomaterial (for example, enzyme) and the like.

### BACKGROUND OF THE INVENTION

“Watermark” is a technology used as one of the methods to determine whether an object is genuine or not, and “watermark” on paper currency exercises its power in preventing damage brought by “counterfeit paper currency” and in authenticating paper currency itself.

However, in the case of the “watermark” on paper currency, for example, an extremely high technology is required for putting such “watermark”, and an enormous cost is required for building a facility to apply such “watermark”.

In a case where articles do not have as much possibility of “forgery” and damage as paper currency, it is possible to apply an identification tag and the like and determine its authenticity by the presence or absence of the “tag” at low cost.

However, there is a possibility that the tag itself is counterfeited because the presence or absence of the tag and the like can be visually recognized with great ease. It is also found at a glance that the tag visually recognizable with ease is a member for determining authenticity.

On the other hand, it has been proposed that a special chemical substance is applied to an object as “watermark” and authenticity is determined by whether or not such a chemical is detected. Such a method is easy to apply “watermark”, and readout of the “watermark” can be very easily performed.

However, there has been a problem that a sensor used in detection of a chemical substance does not have reaction selectivity sufficient for practical application to “watermark”, reacts to substances besides the substance applied as “watermark”, and generates signals indicating “detection of the chemical substance” even though the chemical substance has not been applied.

With recent widespread proliferation of digital technologies, a problem of copying illegally various copyright works is beginning to come to the surface.

In order to counter illegal copying using these digital technologies, a technology so-called “electronic watermark” in which a true copyright holder is specified and data copied illegally by an unauthorized person is displayed as a product of illegal copy is proposed (for example, Patent Documents 1 and 2).

Although such technology of “electronic watermark” is useful, not only is cost necessary for a facility to apply “electronic watermark” to a copyright work relatively high but also objects to put “watermark” are limited to digitized data or its printouts, and thus “electronic watermark” can not be applied to tangible goods that are not connected to electronic equipment.
[Patent Document 1] JP-A No. 2945458/2000
[Patent Document 2] JP-A No. 203994/2003

### SUMMARY OF THE INVENTION

The present invention is proposed in light of the above-mentioned problem of prior art, and the object of the present invention is to provide a “watermark” technology (method of determining authenticity and its apparatus) in which not only can “watermark” be applied to an object without requiring a sophisticated technology and a large cost and be utilized as an aid to determine authenticity by applying “watermark” widely to general tangible goods but also the five senses of human can not sense that “watermark” itself has been applied.

As a result of diligent study, the present inventors have attained the invention of a novel and practical method of determining authenticity and a watermark reader that are quite different from those of conventional “watermark” technologies by focusing attention on the fact that biomaterials (for example, enzymes) are very high in reaction selectivity at the time of biochemical reactions and applying this selectivity.

According to one aspect of the present invention, the method of determining authenticity includes that at least one kind of material (substrate, for example, hydrogen peroxide, lactic acid, choline) is applied (as “watermark” S) to an object (W: object to be authenticated by putting the “watermark” S), whether or not the materials are diffusing from the object is detected by a detecting unit (biosensors 50, 50C, 50L, 50-1 to 50-N) that uses biomaterials (for example, enzymes), whether or not the materials are applied to the object (W) is determined from a result of the detection, and that the authenticity of the object (W) is thus determined (claim 1).

According to another aspect of the present invention, the watermark reader includes the detecting unit (biosensors 50, 50C, 50L, 50-1 to 50-N) to detect one or more kinds of the materials (substrates, for example, hydrogen peroxide, lactic acid, choline) that are applied (as “watermark” S) to the object (W: object to be authenticated by putting the “watermark” S) and are diffusing into the air, the detecting unit (biosensors 50, 50C, 50L, 50-1 to 50-N) being provided with biomaterials (for example, enzymes) that react biochemically with the materials, and a controlling unit (computer 90: analyzing unit 104, storage unit 106, detection code determining unit 108, and comparison-determination unit 110) to analyze and process detection signals from the detecting unit and to identify a composition of substances received by the detecting unit (claim 4).

In the present invention, the materials are preferably hydrogen peroxide, lactic acid, and choline. The biomaterial is preferably catalase that is an enzyme, when hydrogen peroxide is used as the material. The biomaterial is preferably lactic acid oxidase that is an enzyme, when lactic acid is used as the material. The biomaterial is preferably choline oxidase that is an enzyme, when choline is used as the material.

According to still another aspect of the present invention, the method of determining authenticity may comprise using a plurality of kinds of the materials, determining whether each of the plurality of kinds of the materials is contained in substances diffusing from the watermark (S), and identifying a composition of the watermark (S) (code: the kinds of materials composing the watermark S) by the presence or absence of each of the plurality of kinds of the materials (claim 2: refer to embodiment).

According to still another aspect of the present invention, the watermark (S) is composed of the plurality of the materials and the watermark reader may be constructed so that the detecting unit (biosensors 50, 50C, 50L, 50-1 to 50-N) is able to detect at least the plurality of kinds of the materials, and the controlling unit determines whether each of the plurality of kinds of the materials is contained in substances diffusing from the watermark (S) and identifies a composition of the watermark (S) (code: the kinds of materials composing the watermark S) by the presence or absence of each of the plurality of kinds of the materials (claim 5: refer to experimental examples).

According to still another aspect of the present invention, the method of determining authenticity may comprise applying the materials to the object (W) so that amounts of the materials (the amounts of diffusion, the amounts of evaporation, or the amounts of slow release) diffusing (evaporating or slowly released) from the watermark (S) become constant; analyzing the kinds and the concentrations of the detected materials based on the detection signals from the detecting unit (biosensors 50, 50C, 50L, 50-1 to 50-N); and identifying the composition of the watermark (S) (code: the kinds and the addition amounts of materials composing the watermark S) from the kinds and the concentrations of the plurality of materials that are contained in the substances diffusing from the watermark (S) (claim 3).

In the watermark reader used in the method of determining authenticity (claim 3), the controlling unit is constructed so as to analyze the kinds and the concentrations of the detected materials based on the detection signals from the detecting unit (biosensors 50, 50C, 50L, 50-1 to 50-N) and identify the composition of the watermark (S) (code: the kinds and the addition amounts of the materials composing the watermark S) from the kinds and the concentrations of the plurality of materials that are contained in the substances diffusing from the watermark (S) (claim 6).

In order for the amounts of the materials (the amounts of diffusion, the amounts of evaporation, or the amounts of slow release) diffusing (evaporating or slowly released) from the watermark (S) to be made constant, it is possible to apply, for example, a technology of controlled release in the field of aromatics.

When the amounts of the materials (the amounts of diffusion, the amounts of evaporation, or the amounts of slow release) diffusing (evaporating or slowly released) from the watermark (S) are constant, the concentrations of the detected materials and the amounts of the materials added at the time of formulating the watermark (S) show one to one correlation.

According to the method of determining authenticity of the present invention (claim 1) having the above-mentioned advantage of action, the “watermark” can be put on by a simple operation in which specific materials for the “watermark” (S) are applied to an object (W). According to the method of determining authenticity (claim 1) and the watermark reader (claim 4) of the present invention, the presence or absence of the “watermark” can be ascertained by a simple procedure in which whether or not the materials are diffusing from the object is detected by the detecting unit (biosensors 50, 50C, 50L, 50-1 to 50-N) that makes use of biomaterials (for example, enzymes), thereby making it possible to put the “watermark” easily compared to “watermark” and the like put on, for example, paper currency.

In other words, the materials making up the “watermark” are applied to an object, and when the materials are detected, the object to be authenticated is determined to be genuine. When the materials are not detected, the object is determined to be a forgery and counterfeit. Since a simple method allows the “watermark” to be applied to an object and subjected to authentication, labor and cost required for application of the “watermark” and authentication can be reduced to significantly lower levels.

Since biochemical reactions catalyzed by biomaterials such as enzymes having extremely high selectivity in response are used when the presence or absence of “watermark” is determined, it is very unlikely that the detecting unit (biosensors 50, 50C, 50L, 50-1 to 50-N) makes errors in determination due to reaction with substances other than the materials and substrates making up the “watermark”.

Here, the object (W) to be applied with specific materials as “watermark” (S) includes general tangible goods, thus widening the scope of application compared to “electronic watermark”.

Furthermore, when odorless materials and substrates, in particular, are used in the present invention, the presence of the “watermark” is hard to be recognized. Therefore, various illegal acts such as forgery of “watermark” itself become hard to be conducted, and accuracy in determining whether an object is genuine or not is improved, thus exerting easily an effect of determining authenticity.

Here, when construction such that the presence or absence of each of the plurality of kinds of the materials is determined for substances diffusing from the “watermark” (S) and the composition (code) of the “watermark” (S) is specified by the presence or absence of each of plural kinds of the materials is adopted (claims 2 and 5), variations in the “watermark” (S) itself become larger, which gives rise to more difficulty in counterfeiting the “watermark” (S) itself and higher contribution to improvement in authentication.

A simple act of mixing a plurality of the materials composing the “watermark” according to a predetermined composition (code) and applying the mixture to an object allows the “watermark” to be applied to the object for authentication, and therefore, labor and cost required for application of “watermark” can be reduced to significantly lower levels as in the case of the invention in claims 1 and 4.

That is, the materials and substrates composing the “watermark” are mixed with one another, and the mixture can be used as “watermark” except a case that part of the materials and substrates composing the “watermark” decomposes other materials and substrates or reacts with these. Therefore, labor of operation of producing “watermark” and of applying to an object can be reduced to a significantly lower level.

Even in the mixed state, the biosensors targeted to detect each material and substrate detect accurately the materials and substrates diffusing into the air and generate output signals corresponding to the amounts of the materials and substrates diffusing or volatilizing into the air, that is, corresponding to the composition of the materials and substrates in the mixture. As the result, it is possible to determine or read the authenticity with ease even for the “watermark” composed of a mixture.

Further, when the diffusion amounts of the materials and substrates composing the “watermark” are appropriately adjusted and the diffusion amounts and the addition amounts of the materials are made to be correlated in one to one relation, it is possible to construct such that identity of the “watermark” is determined by quantitative analysis of the diffusing materials (claims 3 and 6). When constructed in such a way, it is determined that the composition (code) is different from the right “watermark” if the addition amounts of each of the materials (corresponding to the diffusion amounts) differ even though a person who are going to counterfeit “watermark” specifies the kinds of the materials and substrates composing the “watermark” and counterfeits the “watermark” using the same composition materials. Therefore, forgery of the “watermark” becomes difficult.

Furthermore, when the kinds of the materials and substrates composing the “watermark” are increased, it becomes more difficult to counterfeit the identical “watermark”. Accordingly, it is possible to counter very effectively an illicit act that uses “watermark” itself for “forgery”.

Still further, effective duration of the “watermark” function can be prolonged by the treatment with which the amount of evaporation or the amount of slow release from the materials and substrates composing the “watermark” is adjusted to a desirable level.

In addition, when the “watermark” becomes unnecessary or “watermark” is applied again, and so on, the materials and substrates composing the “watermark” can be removed very easily from the object.

### BRIEF DESCRIPTION OF THE DRAWINGS

FIG. 1 is an illustration for explaining an outline of “watermark” according to an illustrated embodiment;

FIG. 2 is a flow chart showing procedures for applying the “watermark”;

FIG. 3 is a diagram showing an outline of a “watermark” reader according to the illustrated embodiment;

FIG. 4 is a flow chart showing procedures for “watermark” reading;

FIG. 5 is an illustration showing a structure of a biosensor for detection of hydrogen peroxide;

FIG. 6 is an illustration showing a step of a production process of a catalase-immobilized membrane that is a component of the biosensor in FIG. 5;

FIG. 7 is an illustration showing another step in the production process of the catalase-immobilized membrane that is different from the step in FIG. 6;

FIGS. 8A to 8C are illustrations showing an example of an apparatus for a detection experiment using the biosensor for detection of hydrogen peroxide in FIG. 5, where FIG. 8A represents a state that hydrogen peroxide-impregnated filter paper is placed in a sealed container, FIG. 8B represents a state that hydrogen peroxide is diffusing within the sealed container, and FIG. 8C represents the detection apparatus;

FIG. 9 is a graph showing an example of a detection result by the biosensor for detection of hydrogen peroxide in FIG. 5;

FIG. 10 is a graph showing characteristics of the biosensor for detection of hydrogen peroxide in FIG. 5 with respect to hydrogen peroxide concentrations and detection signal outputs;

FIG. 11 is a graph showing an example of a detection result by a biosensor for detection of lactic acid;

FIG. 12 is a graph showing characteristics of the biosensor for detection of lactic acid with respect to lactic acid concentrations and detection signal outputs;

FIG. 13 is a graph showing an example of a result detected by a biosensor for detection of choline;

FIG. 14 is a graph showing characteristics of the biosensor for detection of choline with respect to choline concentrations and detection signal outputs;

FIG. 15 is a diagram showing an experimental apparatus for a reading experiment using the biosensor for detection of hydrogen peroxide, the biosensor for detection of lactic acid, and the biosensor for detection of choline; and

FIGS. 16-1 and 16-2 represent patterns of the presence or absence of substrates, where FIG. 16-1 is an illustration showing patterns of mixing based on the presence or absence of hydrogen peroxide, lactic acid, and choline in tabular form, and FIG. 16-2 is an illustration showing patterns of the presence or absence of signals detected by the biosensor for detection of hydrogen peroxide, the biosensor for detection of lactic acid, and the biosensor for detection of choline in tabular form.

### DETAILED DESCRIPTION OF THE PREFERRED EMBODIMENTS

Hereinafter, an embodiment of the present invention is explained with reference to the accompanying drawings.

First, an outline of “watermark” according to the embodiment of the present invention is explained with the use of FIG. 1.

An object for which authenticity is determined using the “watermark” is shown by a reference symbol W in FIG. 1.

In the illustrated embodiment, four kinds of materials (or substrates) represented by reference symbols A to D are selected for composition materials of the “watermark”.

Although materials (odorant) having a level of odor that can be perceived by an ordinary person can be selected for the materials (substrates) A to D, it is preferred for the materials A to D to be composed of odorless materials such as hydrogen peroxide, lactic acid, and choline considering that the essential function of the “watermark” lies in determination of authenticity. As long as these materials are odorless, a third party can not ascertain that the “watermark” is applied to the object W. Therefore, there is less possibility that an illegal act on “watermark” itself such as counterfeit of “watermark” is committed.

Next, a mixture M is prepared by mixing the selected materials A to D, and a predetermined amount of the mixture M is applied to the object W.

In FIG. 1, the mixture M is dropped with a pipette P. However, any method besides dropping with a pipette may be employed without particular limitation as long as the method enables a predetermined amount of the mixture M to be applied to the object W.

The materials A to D diffuses or evaporates from the mixture M (shown by a reference symbol S in FIG. 1) applied to the object W to make up a “watermark”.

By detecting the materials A to D diffusing from the “watermark” S with a biosensor and the like, the presence or absence of the “watermark” S is determined. That is, when the presence of the “watermark” S is ascertained, the object W is right and “genuine”. In contrast, when the “watermark” S is determined to be absent, the object is a forgery imitating the right object, that is, “counterfeit”.

When the “watermark” S is prepared by mixing N kinds of materials (N represents a natural number), “2^{N}” possible combinations can be detected based on the presence or absence of the N kinds of materials.

In addition to this, when the amounts of diffusion (the amounts of evaporation or the amounts of slow release) from the “watermark” S composed of the N kinds of materials are adjusted, it is possible to detect still more combinations.

Assuming that one hundred possible combinations of adjustable concentrations exist for each of the N kinds of materials in a range where the amount of diffusion can be accurately determined by quantitative analysis, the number of combinations of the “watermark” S composed of the N kinds of materials becomes “100^{N}” possible combinations.

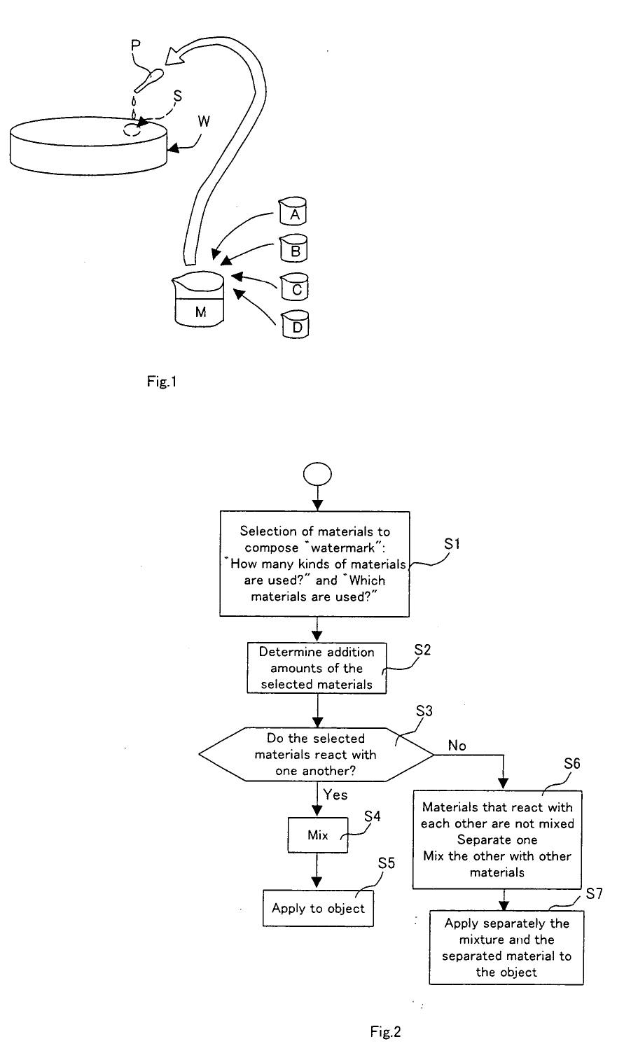

An operation to apply such “watermark” S to the object W is explained in more detail with reference to FIG. 2.

When the “watermark” S is applied to the object W, materials to make up the “watermark” S, e.g. the materials A to D in the example in FIG. 1, are selected. In more detail, the number of kinds of the materials (How many kinds of materials are selected?: Four kinds in the example in FIG. 1) and the kinds of materials (What kinds of materials are selected?: Materials A to D in the example in FIG. 1) are both determined (step S1 in FIG. 2).

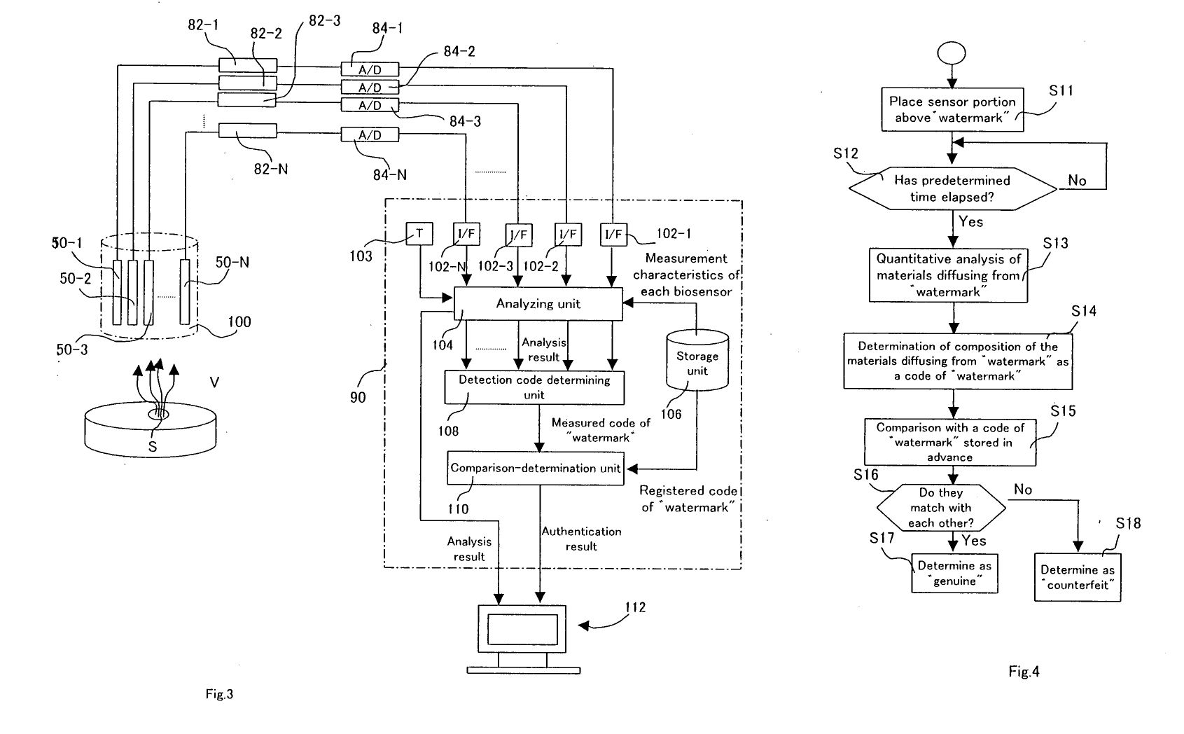

The materials to be selected are chosen from materials detectable by any one of the biosensors 50-1 to 50-N in FIG. 3. The materials are preferably selected from odorless materials as described above in relation to FIG. 1.

When the “watermark” S is regarded as a kind of identification code, the larger the number of the identification codes becomes, the more difficult the forgery of the “watermark” S becomes, and accuracy of determining authenticity with the use of the “watermark” S is improved. Both of “the number of kinds of selected materials” and “the kinds of selected materials” are factors determining the number of codes of the “watermark” S.

Then, in step S2, the amount of addition is determined for every selected material. The amount of addition to be determined here represents a numerical value of the material diffusing from the “watermark” S that can be accurately detected by a biosensor described later.

When the amount of diffusion (or the amount of evaporation/the amount of slow release) from the “watermark” S is adjusted, an amount of addition of the material corresponding to the amount of diffusion that can be determined by a quantitative analysis by a biosensor is selected.

At this stage, it is studied whether or not one component decomposes other components due to reaction of the materials making up the “watermark” S with one another or whether or not compounds inappropriate for the “watermark” S are produced by chemical reaction (step S3).

When such a reaction does not occur mutually among the materials (Yes at the step S3), the selected materials are mixed with one another (step S4) and applied to the object W (step S5).

When the materials react mutually (No at the step S3), one reacting material is separated from the other reacting material so as to avoid mixing the mutually reacting materials, and only the other reacting material is mixed with other materials (step 6).

In addition, when the mixture is applied to the object W as “watermark” S, the material separated at the step S6 is kept from contact with the mixture of the other materials so as to be separated from each other, that is, the “watermark” S is applied over a plurality of places of the object W (step 7).

In the foregoing, application of the “watermark” S is completed.

Reading of the “watermark” S explained in FIGS. 1 and 2 is explained with reference to FIGS. 3 and 4.

FIG. 3 illustrates the composition of a “watermark” S reader, and FIG. 4 illustrates a reading process of the “watermark” S.

In FIG. 3, the reader is provided with a sensor portion 100, a controlling unit 90 composed of, for example, a computer, and a displaying unit 112 (for example, display) that displays determination results and measurement results.

The sensor portion 100 includes a plurality of biosensors 50-1 to 50-N in its inside, and detection signals from the plurality of biosensors 50-1 to 50-N are converted to analog current signals by current measuring units 82-1 to 82-N. These converted signals are then converted to digital signals by A/D converters 84-1 to 84-N and are input to the controlling unit 90.

In order to eliminate noises and lessen the possibility of improper operation, a construction that allows signals below a predetermined level to be cut off by placing filters in transmission circuits for output signals from the biosensors 50-1 to 50-N may also be employed.

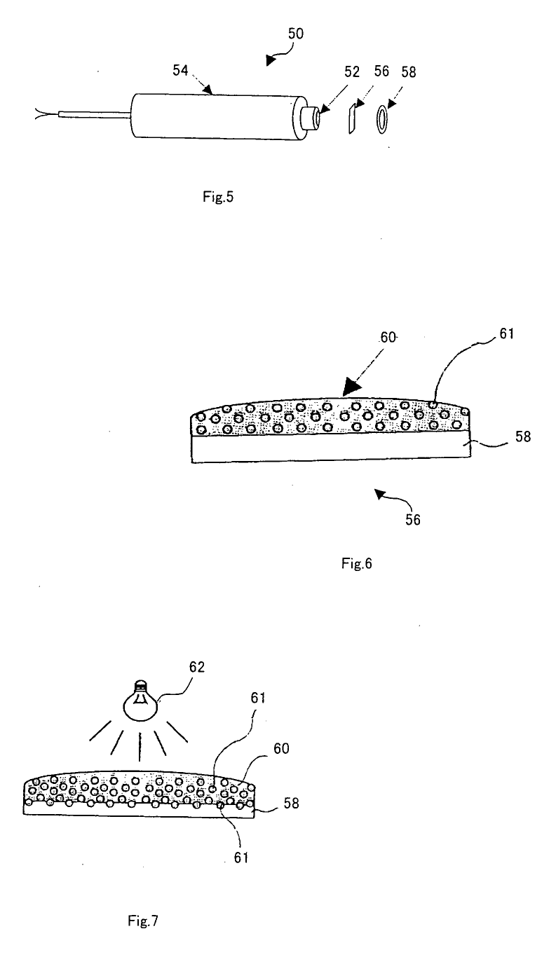

The structure of the biosensors 50-1 to 50-N is, for example, the same as that to be described later with reference to FIG. 5.

Although not explicitly illustrated in FIG. 3, the biosensors 50-1 to 50-N are provided with different biochemical materials (for example, enzymes), and selectivity for substances that become detection objects are extremely high. Therefore, there is no chance of generating detection signals due to reacting with substances other than the selected object as is often the case with conventionally and commercially available gas sensors.

The materials diffusing from the “watermark” S (the materials selected at the step S1 in FIG. 2) are sensed by any of the biosensors 50-1 to 50-N in the sensor portion 100.

In FIG. 3, the materials diffusing from the “watermark” S are represented by curvedly depicted arrows V.

The biosensors 50-1 to 50-N having detected the presence of the diffusing materials V generate detection signals, and the detection signals are input to the controlling unit 90 via the current measuring units 82-1 to 82-N and the A/D converters 84-1 to 84-N.

The detection signals (digital signals) having been input to the controlling unit 90 are input to the analyzing unit 104 via interfaces 102-1 to 102-N.

On the other hand, measurement characteristics of each of the biosensors 50-1 to 50-N (refer to FIGS. 9 to 14 in examples described later) are transmitted from the storage unit (for example, database) 106 to the analyzing unit 104.

The analyzing unit 104 compares the measurement characteristics of the biosensors 50-1 to 50-N transmitted from the storage unit 106 with measurement results transmitted through the interfaces 102-1 to 102-N and determines from which biosensor each signal was output with regard to the respective input signals. In conjunction with this, concentrations of the materials detected by the biosensors are also determined at the same time.

Here, the analyzing unit 104 initiates the comparison and determination described above after a predetermined time has passed since the detection signals were input via the interfaces 102-1 to 102-N.

This is because, as evidenced by referring to FIGS. 9 to 14 in the examples described later, the above determination, particularly the determination of concentration, cannot be accurately carried out until after the outputs from the biosensors 50-1 to 50-N become constant (saturated). The biosensors 50-1 to 50-N sometimes require 3 to 4 minutes before their outputs are stabilized (saturated).

The predetermined time described above (time required for saturation of the output signals from the biosensors 50-1 to 50-N) is measured with a timer 103.

The results of analysis and determination by the analyzing unit 104 are sent to the detection code determining unit 108, which determines the composition of the “watermark” S, i.e. the materials making up the “watermark” S (the materials making up the “watermark” S and their addition amounts when the amounts of diffusion are adjusted), obtained by the output signals from the biosensors 50-1 to 50-N.

As described above, the “composition” of the “watermark” S is not single but can be in a plurality of combinations, and therefore is represented by “code” in the present specification.

The code determined by the detection code determining unit 108, that is, the composition of the “watermark” S determined on the basis of the output signals from the biosensors 50-1 to 50-N, is transmitted to the comparison-determination unit 110 to be compared with the code (composition) of the “watermark” S stored in the storage unit 106 in advance.

When both matches with each other, the comparison-determination unit 110 determines that the “watermark” S applied to the object W is genuine.

When both do not match with each other, the comparison-determination unit 110 determines that the “watermark” S applied to the object W is not the genuine “watermark” S but a counterfeit “watermark” S and that the object W is not genuine but counterfeit.

The result from determination by the comparison-determination unit 110 and the result from analysis and determination by the analyzing unit 104 are displayed on the displaying unit 112, and a user (not shown) can be informed of its authenticity by the display on the displaying unit 112.

The readout of the “watermark” S by the reader in FIG. 3 is explained with reference to FIG. 4.

First, the sensor portion 100 is placed above the “watermark” S of the object W so that the biosensors 50-1 to 50-N in the sensor portion 100 might receive the diffusing materials V (step S11 in FIG. 4).

Then, whether or not a predetermined time has passed is determined by the timer 103 (step S12). Measurement is waited until the predetermined time elapses (the step S12 is No) because the output signals from the biosensors 50-1 to 50-N are not saturated.

Here, the starting point of the step S12 is set at the time when an output signal is generated from any one of the biosensors 50-1 to 50-N. However, when signals below a predetermined level is cut off by placing filters in the transmission circuits for output signals from the biosensors 50-1 to 50-N or when the “watermark” S is a “watermark” for a blank test, that is, the “watermark” S is not diffusing any materials, the starting point for measurement of time by the timer 103 is set at the moment when the sensor portion 100 is placed above the “watermark” S of the object W.

Once the output signals from the biosensors 50-1 to 50 N are saturated and stabilized after the predetermined time has elapsed, quantitative analysis is carried out by the analyzing unit 104 with reference to the measurement characteristics of the biosensors 50-1 to 50-N stored in the storage unit 106 in advance (step S12). Namely, from which biosensor each detection signal was output is determined, and at the same time, the concentration of the material is also determined.

Then, the code (composition) of the “watermark” S, that is, the materials making up the “watermark” S are determined by the detection code determining unit 108 using the quantitative analysis (data on detected materials and their concentrations)(step S14). At this time, when the amounts of addition corresponding to the amounts of diffusion of materials are included in the combination as a kind of the “watermark” S (when the amounts of diffusion of the materials are adjusted), the materials making up the “watermark” S and their amounts of addition are determined.

The code of the “watermark” S (the code determined by the detection code determining unit 108) determined in the step S14 is compared with the code (composition) of “watermark” S stored in the storage unit 106 in advance by the comparison-determination unit 110 (step S15, step S16).

When both matches with each other (step S16 is Yes), it is determined that the “watermark” S applied to the object W is genuine (step S17).

On the other hand, when the code of the “watermark” S determined in the step S14 does not match with the code stored in advance (the step S16 is No), it is determined that the “watermark” S applied to the object W is not a genuine “watermark” S but a counterfeit “watermark” S and that the object W is not genuine but counterfeit (step S18).

### EXAMPLES

Hereinafter, examples in which the action of the above-mentioned embodiment was confirmed using an experimental apparatus are explained.

In an example explained below, three kinds of materials of hydrogen peroxide (H₂O₂), lactic acid, and choline were used as colorless and odorless materials to be used for information codes.

Hydrogen peroxide is an agent that is used for bleaching and disinfectant of clothing and the like, and lactic acid is a substance accumulated in muscles by anaerobic exercise of short duration. Choline is a kind of vitamin B group and has an action to regulate fat metabolism.

FIGS. 5 to 8 illustrate the structure of a biosensor, particularly a biosensor 50 for detection of hydrogen peroxide, used in the example.

The biosensor wholly represented by a reference numeral 50 in FIG. 5 is provided with an oxygen electrode 54 having a sensing element 52, and the sensing element 52 is provided with a catalase-immobilized membrane 56 that is a membranous member to which an enzyme called catalase (EC 1.11.1.6) is fixed and a silicone O-ring 58 that serves as a fixing ring to attach the catalase-immobilized membrane 56 to the sensing element 52.

The oxygen electrode 54 is constructed as a so-called “Clark-type oxygen electrode”. Although not accurately depicted, the oxygen electrode 54 is constructed such that two electrodes (platinum electrode and silver electrode) are provided in a cylindrical vessel filled with an electrolyte (potassium chloride solution) and that oxygen molecules flowing in from one end of the cylindrical vessel are detected by an electrochemical reaction between the two electrodes. By applying a constant voltage (−700 mV vs. Ag) between the two electrodes, oxygen is quantitatively analyzed from a change in current value at the time of the electrochemical reaction that occurs in the presence of oxygen molecules.

The catalase-immobilized membrane 56 is produced in a manner shown in FIGS. 6 and 7.

That is, first, a dialysis membrane 58 in a thickness of 15 micrometers is applied and coated with a mixture 60 of catalase and a photo-crosslinking resin (PVA-SbQ) as shown in FIG. 6. In FIG. 6, catalase is shown by a plurality of particles 61. After the applied mixture 60 is dried, the catalase 61 is inclusively immobilized on the dialysis membrane 58 by irradiation with a fluorescent lamp 62 as shown in FIG. 7.

The principle of detection of hydrogen peroxide by the biosensor 50 shown in FIG. 5 is explained.

As shown by the following equation, hydrogen peroxide H₂O₂ is decomposed to H₂O and O₂ in the presence of catalase.
2H₂O₂→2H₂O+O₂

That is, when catalase is allowed to be present in an environment where hydrogen peroxide is present, oxygen concentration rises due to the action of catalase. When the oxygen concentration increases, a constant voltage (−700 mV vs. Ag) is applied between the two electrodes (not shown) in the oxygen electrode 54, and the oxygen concentration can be detected as a change in the current value.

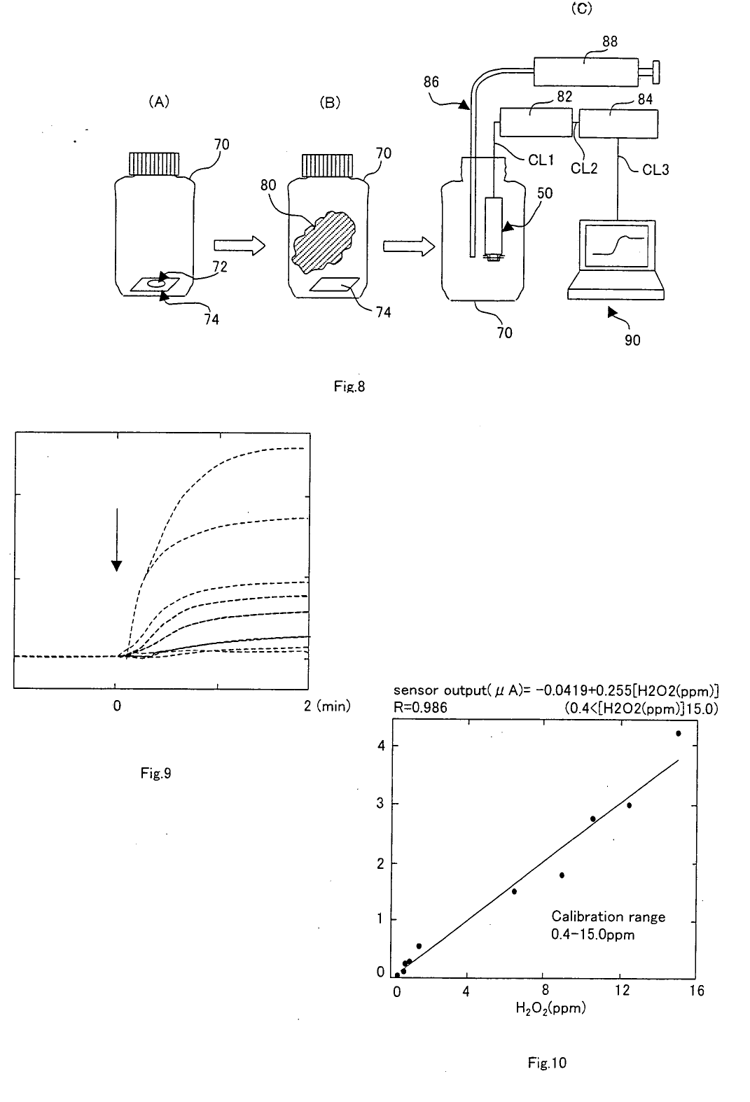

An example of experiment to detect a hydrogen peroxide concentration by the biosensor 50 shown in FIG. 5 is illustrated in FIGS. 8A to 8C.

In FIG. 8A, a piece of filter paper 70 impregnated with a solution of hydrogen peroxide was left in a sealed container 70, and hydrogen peroxide was allowed to diffuse within the sealed container 70 at room temperature as shown in FIG. 8B.

Then, the biosensor 50 for detection of hydrogen peroxide was inserted into the sealed container 70 filled with hydrogen peroxide as shown in FIG. 8C.

The output signal from the biosensor 50 was measured by a current measuring device 82 (for example, potentiostat) via a signal transmission line CL1, and the result of the measurement by the current measuring device 82 was converted into digital form by the A/D converter 84 via a signal transmission line CL2. The signal converted into digital form was input to the controlling unit 90 (for example, computer) via a signal transmission line CL3 and processed.

Here, the apparatus is constructed such that hydrogen peroxide in the sealed container 70 is supplied to a commercially available sensor 88 for hydrogen peroxide gas via a tube 86 and calibrated.

A result of the detection experiment using the experimental apparatus illustrated in FIGS. 8A to 8C is shown in FIG. 9.

As is evident from FIG. 9, the output signals from the biosensor 50 reached approximately a saturated state after a predetermined time elapsed from the start of the detection, and gave rise to certain values depending on each concentration of hydrogen peroxide. With the use of these values (values in the saturated state after a predetermined time, for example, 2 min, elapsed from the start of the detection), characteristics between hydrogen peroxide and output signals from the biosensor 50 are depicted in FIG. 10.

As is evident from FIG. 9, when the output signals in the saturated state are determined, a corresponding relation of 1 to 1 is obtained between the concentration of hydrogen peroxide and the output signal.

The structures of biosensors for detection of lactic acid and choline are basically the same as that of the biosensor 50 for detection of hydrogen peroxide shown in FIG. 5.

The enzyme, catalase, was used in the biosensor for detection of hydrogen peroxide, while an enzyme, lactic acid oxidase, is used in a biosensor for detection of lactic acid, and an enzyme, choline oxidase, is used in a biosensor for detection of choline.

The principle of detection of lactic acid by the biosensor using lactic acid oxidase is explained.

In the presence of lactic acid oxidase, lactic acid consumes oxygen to be decomposed to pyruvic acid, carbon dioxide (CO₂), and water (H₂O). That is, the reaction proceeds as shown below;
Lactic acid+O₂→Pyruvic acid+CO₂+H₂O
As the result, the concentration of oxygen decreases, and therefore, quantitative analysis of lactic acid is made possible by detecting the decrease in the concentration of oxygen with the use of oxygen electrode having a structure similar to that shown in FIG. 5.

The principle of detection of choline by the biosensor using choline oxidase is also similar.

In the presence of choline oxidase, choline also consumes oxygen to be decomposed to fatty acid, carbon dioxide (CO₂), and hydrogen peroxide (H₂O₂). That is, the reaction proceeds as shown below, and oxygen concentration decreases.
Choline+O₂→Fatty acid+CO₂+H₂O₂
Quantitative analysis of choline is made possible by detecting the decrease in the concentration of oxygen with the use of oxygen electrode having a structure similar to that shown in FIG. 5.

The detection result and detection characteristics of the biosensor for detection of lactic acid and the detection result and detection characteristics of the biosensor for detection of choline are similar to those of the biosensor 50 for detection of hydrogen peroxide in FIGS. 9 and 10.

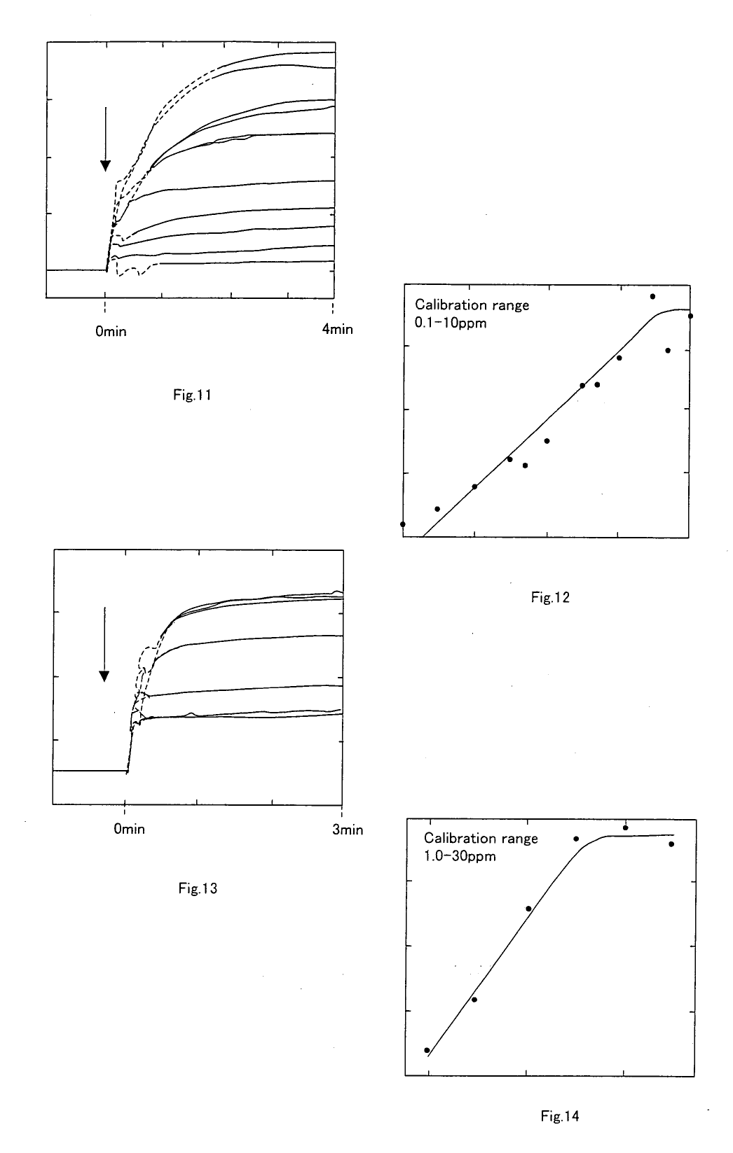

The detection result with the biosensor for detection of lactic acid is illustrated in FIG. 11, and characteristics between lactic acid concentrations and output signals from the biosensor for detection of lactic acid are depicted in FIG. 12. In FIG. 11, the time when the output signals from the biosensor for detection of lactic acid reached a saturated state was an elapsed time point of 4 min from the start of the detection.

The detection result with the biosensor for detection of choline is illustrated in FIG. 13, and characteristics between choline concentrations and output signals from the biosensor for detection of choline are depicted in FIG. 14. In FIG. 13, the time when the output signals from the biosensor for detection of choline reached a saturated state was after 3 min had elapsed from the start of the detection.

In the foregoing, evaluation of detection characteristics of the biosensors used in the example, that is, the biosensor for detection of hydrogen peroxide, the biosensor for detection of lactic acid, and the biosensor for detection of choline was completed for each object of detection.

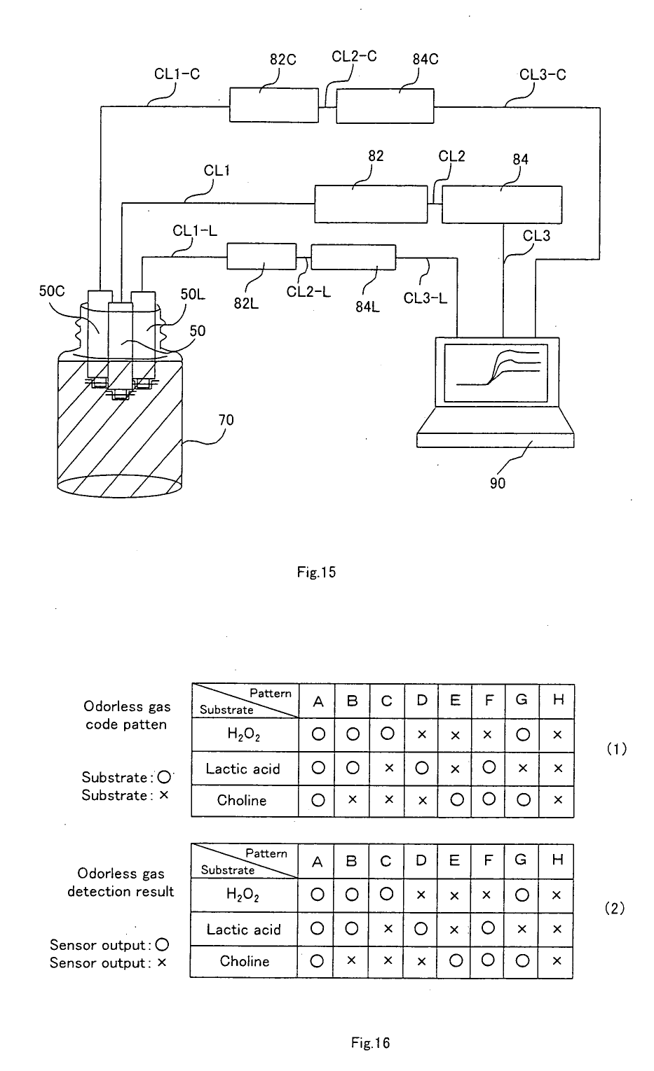

FIG. 15 depicts an example of an odorless watermark reader constructed by the use of the biosensors (the biosensor 50 for detection of hydrogen peroxide, a biosensor 50L for detection of lactic acid, and a biosensor 50C for detection of choline) of which evaluation of characteristics was completed.

Since the structure of the reader shown in FIG. 15 shares common features to that of the apparatus shown in FIG. 8C, like elements are designated by like reference numerals in FIGS. 15 and 8.

In FIG. 8C, only the biosensor 50 for detection of hydrogen peroxide is inserted into the sealed container 70, whereas in the odorless watermark reader shown in FIG. 15, the biosensor 50L for detection of lactic acid and the biosensor 50C for detection of choline are inserted into the sealed container 70 in addition to the biosensor 50 for detection of hydrogen peroxide.

All of the biosensor 50 for detection of hydrogen peroxide, the biosensor 50L for detection of lactic acid, and the biosensor 50C for detection of choline which are used in FIG. 15 have been through the evaluation of their detection characteristics for each detection object as described in FIGS. 5 to 14. Therefore, in FIG. 15, there is no need to arrange a structure like the one shown in FIG. 8C (tube 86, commercially available gas sensor 88 for hydrogen peroxide).

In addition to this, in FIG. 15, data transmission circuits to transmit data (detection signals converted into digital form) to the controlling unit 90 via the current measuring devices and the A/D converters are arranged for each of the biosensor 50 for detection of hydrogen peroxide, the biosensor 50L for detection of lactic acid, and the biosensor 50C for detection of choline.

That is, the output signals from the biosensor 50 are input to the controlling unit 90 via the signal transmission line CL1, the current measuring device 82, the transmission line CL2, the A/D converter 84, and the signal transmission line CL3, and are converted into digital form along the way by the A/D converter 84. The output signals from the biosensor 50L for detection of lactic acid, and the output signals from the biosensor 50C for detection of choline are also converted into digital form and sent to the controlling unit 90. Here, a suffix “L” is added to the components of the circuit to transmit detection signals from the biosensor 50L for detection of lactic acid, and a suffix “C” is added to the components of the circuit to transmit detection signals from the biosensor 50C for detection of choline.

Other structures of the apparatus of the example in FIG. 15 are approximately the same as those in FIG. 8C.

Although not shown in FIGS. 8C and 15, processing by the controlling unit 90 is not performed right after any one of the biosensors 50, 50L, and 50C has generated detection signals but necessary processing is performed after the detection signals have been saturated and stabilized.

For this purpose, a timer not shown (similar to the timer 103 in FIG. 3) is provided in the controlling unit 90, thus allowing the processing to be suspended or delayed until the detection signals from the biosensors 50, 50L, and 50C reach saturation levels.

As described above, according to the present invention, the apparatus can be constructed so as to carry out pattern recognition by detecting quantitatively the amounts or concentrations of added materials or substrates (preferably odorless materials such as hydrogen peroxide, lactic acid, and choline, but materials having an odor also applicable). In the present example, pattern recognition is performed by determining the presence or absence of the three kinds of materials of hydrogen peroxide, lactic acid, and choline.

Based on the presence or absence of hydrogen peroxide, lactic acid, and choline (the presence or absence of materials or substrates), 2³=8 possible patterns are defined. These eight patterns are shown in FIG. 16-1.

On the other hand, 2³=8 possible patterns are defined with respect to whether hydrogen peroxide is detected by the biosensor 50 for detection of hydrogen peroxide (in other words, the output signals from the biosensor 50 for detection of hydrogen peroxide have reached a current level higher than a predetermined level in a saturated state), whether lactic acid is detected by the biosensor 50L for detection of lactic acid (in other words, the output signals from the biosensor 50L for detection of lactic acid have reached a current level higher than a predetermined level in a saturated state), and whether choline is detected by the biosensor 50C for detection of choline (in other words, the output signals from the biosensor 50C for detection of choline have reached a current level higher than a predetermined level in a saturated state). These patterns are shown in FIG. 16-2.

Accordingly, the presence or absence of hydrogen peroxide, lactic acid, and choline and the presence or absence of detection by the biosensors 50, 50L, and 50C (the presence or absence of detection signals that have reached current levels higher than predetermined levels) can be correlated in one to one relation.

In the experiments using the reader shown in FIG. 15, a gas having any one pattern of the eight patterns in FIG. 16-1 was first filled in the sealed container 70, detected by the biosensors 50, 50L, and 50C, and then classified into any one of the eight patterns in FIG. 16-2 based on the presence or absence of detection signals that reached current levels higher than predetermined levels.

Then, it was examined whether the pattern classified by the presence or absence of detection signals matched with the pattern of the gas filled in the container 70.

In these experiments, the patterns classified by the presence or absence of the detection signals matched with the pattern of the gas filled in the sealed container 70 in all of the eight patterns. In other words, it was possible to determine accurately to which pattern in FIG. 16-1 the composition of the gas filled in the sealed container 70 corresponded in the experiments using the reader shown in FIG. 15.

Hence, it was experimentally demonstrated that when a mixture that was appropriately selected from hydrogen peroxide, lactic acid, and choline was applied to an object to be recognized as a kind of “watermark” and the volatile gases from the mixture were read using the reader shown in FIG. 15, it was possible to know the composition of the mixture applied to, in other words, it was possible to read the “watermark”.

In the foregoing example, identity of the “watermark” is recognized by the presence or absence of hydrogen peroxide, lactic acid, and choline, and the kind of the “watermark” comes to 2³=8 combinations. Provided that the amounts of diffusion (the amounts of evaporation, the amounts of slow release) from each of hydrogen peroxide, lactic acid, and choline can be each adjusted to a predetermined level, the number of kinds of the “watermark” is dramatically increased.

From FIG. 10, it is understood that the accurate concentration of hydrogen peroxide measurable by quantitative analysis is from 0.4 ppm to 15.0 ppm. Here, accurate measurement of the concentration requires a difference in the concentration of at least ca. 0.5 ppm. Therefore, with respect to the concentration of hydrogen peroxide, addition amounts corresponding 30 kinds of diffusion amounts can be set.

Similarly, from FIG. 12, the concentration of lactic acid that can be accurately determined by quantitative analysis is from 0.1 ppm to 10.0 ppm. When accurate measurement of the concentration requires a difference in the concentration of at least ca. 0.5 ppm, addition amounts corresponding 20 kinds of diffusion amounts can be set.

Further from FIG. 14, the concentration of choline that can be accurately determined by quantitative analysis is from 1.0 ppm to 30.0 ppm. When accurate measurement of the concentration requires a difference in the concentration of at least ca. 1.0 ppm, addition amounts corresponding to 30 kinds of diffusion amounts can be set.

As the result, when a “watermark” is made from three materials (hydrogen peroxide, lactic acid, and choline) used in the example and if their diffusion amounts can be adjusted, 30×20×30=18,000 kinds of the “watermark” can be generated because the kind of the “watermark” can be varied according to every addition amount of each material.

When the number of kinds of the “watermark” increases, forgery of the “watermark” becomes difficult, and determination of authenticity by the “watermark” becomes more effective.

It should be noted that the illustrated embodiments and examples are merely illustrative and are not intended as a definition of the technological limits of the present invention.

For example, odorless materials are utilized for the “watermark” in the illustrated embodiments and examples. However, materials having a level of odor perceivable by human olfaction can also be utilized for the “watermark” of the present invention.

1. A method of determining authenticity, comprising the steps of:
applying at least one kind of material to an object;
detecting whether or not the material is diffusing from the object by a detecting means that uses a biomaterial;
determining whether or not the material has been applied to the object from a result of the detection; and
determining the authenticity of the object.

2. The method of determining authenticity according to claim 1, wherein a plurality of kinds of the materials are used; the plurality of kinds of the materials are determined as to whether each of the materials is contained in substances diffusing from a watermark; and a composition of the watermark is identified by the presence or absence of each of the plurality of kinds of the materials.

3. The method of determining authenticity according to any one of claims 1 and 2, wherein the materials are applied to the object so that amounts of the materials diffusing from the watermark become constant; the kinds and concentrations of the materials that are detected are analyzed based on detection signals from the detecting means; and the composition of the watermark is identified from the kinds and the concentrations of the plurality of materials that are contained in the substances diffusing from the watermark.

4. A watermark reader comprising:
a detecting means to detect one or more kinds of materials that are applied to an object and are diffusing into the air, the detecting means having biomaterials that react biochemically with the materials; and
a controlling means to analyze and process detection signals from the detecting means and to identify a composition of substances received by the detecting means.

5. The watermark reader according to claim 4, wherein a watermark is composed of a plurality of the materials; and the watermark reader is constructed such that the detecting means is able to detect at least the plurality of kinds of the materials and the controlling means determines whether each of the plurality of kinds of the materials is contained in the substances diffusing from the watermark and identifies a composition of the watermark by the presence or absence of each of the plurality of kinds of the materials.

6. A watermark reader, comprising:
a detecting means to detect one or more kinds of materials that are applied to an object and are diffusing into the air, the detecting means having biomaterials that react biochemically with the materials; and
a controlling means to analyze and process detection signals from the detecting means and to identify a composition of substances received by the detecting means,
wherein the watermark reader is used in the method of determining authenticity according to claim 3 and is constructed such that the controlling means analyzes the kinds and concentrations of the materials that are detected based on the detection signals from the detecting means and identifies the composition of the watermark from the kinds and the concentrations of the plurality of materials that are contained in the substances diffusing from the watermark.

7. A watermark reader comprising:
a detecting means to detect one or more kinds of materials that are applied to an object and are diffusing into the air, the detecting means having biomaterials that react biochemically with the materials; and
a controlling means to analyze and process detection signals from the detecting means and to identify a composition of substances received by the detecting means,
wherein a watermark is composed of a plurality of the materials; and the watermark reader is constructed such that the detecting means is able to detect at least the plurality of kinds of the materials and the controlling means determines whether each of the plurality of kinds of the materials is contained in the substances diffusing from the watermark and identifies a composition of the watermark by the presence or absence of each of the plurality of kinds of the materials,
wherein the watermark reader is used in the method of determining authenticity according to claim 3 and is constructed such that the controlling means analyzes the kinds and concentrations of the materials that are detected based on the detection signals from the detecting means and identifies the composition of the watermark from the kinds and the concentrations of the plurality of materials that are contained in the substances diffusing from the watermark.
